(19) United States
(12) Patent Application Publication
(10) Pub. No.: US 2023/0088302 A1
(43) Pub. Date: Mar. 23, 2023

(54) LIFE PREDICTION DEVICE

(71) Applicant: FANUC CORPORATION, Minamitsuru-gun, Yamanashi (JP)

(72) Inventors: Hidenori KUREBAYASHI, Yamanashi (JP); Yoshifumi SHIMURA, Yamanashi (JP)

(21) Appl. No.: 17/911,007

(22) PCT Filed: Jun. 17, 2021
(86) PCT No.: PCT/JP2021/022999

§ 371 Date: Sep. 12, 2022

(30) Foreign Application Priority Data
Jun. 22, 2020 (JP) 2020-107137

(51) Int. Cl. G05B 23/02; B25J 9/16; B25J 13/08; B25J 19/00

(52) U.S. Cl. CPC G05B 23/0283; G05B 23/0272; B25J 9/1674; B25J 13/088; B25J 19/0066

(57) ABSTRACT

In order to alleviate a user's burden of maintenance, the present invention calculates an actual lifetime of a cable, which is the intrinsic lifetime of the cable, and extends cable replacement cycles. Provided is a lifetime prediction device for a cable used in an industrial machine, the lifetime prediction device being provided with: a motion amount analysis unit that analyzes a motion amount of a motion axis of the industrial machine on the basis of a motion program for operating the industrial machine; and a lifetime calculation unit that calculates a predicted value of a lifetime of the cable by applying to the motion amount a relational expression between the motion amount and the lifetime of the cable based on the Eyring model.

### TECHNICAL FIELD

The present invention relates to a life prediction device for a cable used in an industrial machine.

### BACKGROUND ART

A cable of a movable part of an industrial machine needs to be periodically replaced because of deterioration accompanying motion of the industrial machine. Conventionally, a replacement interval of the cable is decided on the assumption that a motion axis of the industrial machine performs the maximum motion (see, for example, Japanese Unexamined Patent Application, Publication No. 2014-233763).
Patent Document 1: Japanese Unexamined Patent Application, Publication No. 2014-233763

### DISCLOSURE OF THE INVENTION

### Problems to be Solved by the Invention

The motion of an industrial machine, however, varies depending on content of a task, and the motion axis does not necessarily perform the maximum motion.

However, since an industrial machine and a controller therefor do not have means for calculating the life of the cable, periodic replacement is performed at an interval during which the motion axis of the industrial machine is assumed to perform the maximum motion. As a result, replacement of the cable is performed at an interval shorter than an actual life of the cable, which is an original life of the cable.

It is desirable to, in order to reduce a maintenance burden on a user, calculate the actual life of the cable, which is the original life of the cable, and extend the interval of replacement of the cable.

### Means for Solving the Problems

One aspect of the present disclosure is directed to a life prediction device for a cable used in an industrial machine. The life prediction device includes: a motion amount analysis unit that analyzes a motion amount of a motion axis of the industrial machine based on a motion program for causing the industrial machine to operate; and a life calculation unit that calculates a predicted value of a life of the cable by applying a relational expression between motion amount and cable life based on an Eyring model to the motion amount.

Another aspect of the present disclosure is directed to a life prediction device for a cable used in an industrial machine. The life prediction device includes: a motion amount analysis unit that analyzes a motion amount of a motion axis of the industrial machine based on a motion program for causing the industrial machine to operate; a stress calculation unit that calculates stress that occurs on the cable, by applying a relationship between motion amount and stress on the cable to the motion amount; and a life calculation unit that calculates a predicted value of a life of the cable by applying a relational expression between stress and cable life based on an Eyring model to the stress.

### Effects of the Invention

According to one aspect, it becomes possible to, in order to reduce a maintenance burden on a user, calculate an actual life of a cable, which is an original life of the cable, and extend the interval of replacement of the cable.

### BRIEF DESCRIPTION OF THE DRAWINGS

FIG. 1 is an overall configuration diagram of a life prediction system according to one embodiment;

FIG. 2 is an appearance of an industrial machine according to the one embodiment;

FIG. 3 is a functional block diagram of the life prediction device according to the one embodiment;

FIG. 4 is a diagram showing an example of a motion program according to the one embodiment;

FIG. 5 is a graph showing an example of motion of an axis in one cycle of the motion program according to the one embodiment;

FIG. 6A is a diagram showing an example of a method for a life test according to the one embodiment;

FIG. 6B is a diagram showing the example of the method for the life test according to the one embodiment;

FIG. 7 is a graph showing a relationship between twisting angle and cable life according to the one embodiment;

FIG. 8 is a graph showing a motion example of the axis according to the one embodiment;

FIG. 9 is a graph showing a motion example of the axis according to the one embodiment;

FIG. 10 is a graph showing a motion example of the axis according to the one embodiment;

FIG. 11 is a functional block diagram of a life prediction device according to one embodiment;

FIG. 12 is a graph showing a relationship between axial angle and stress in the one embodiment;

FIG. 13 is a diagram showing a method for a life test according to the one embodiment;

FIG. 14 is a graph showing a relationship between stress and cable life according to the one embodiment;

FIG. 15 is a graph showing a stress fluctuation example in the one embodiment;

FIG. 16 is a functional block diagram of a life prediction device according to one embodiment; and

FIG. 17 is a functional block diagram of a life prediction device according to one embodiment.

### PREFERRED MODE FOR CARRYING OUT THE INVENTION

### 1 First Embodiment

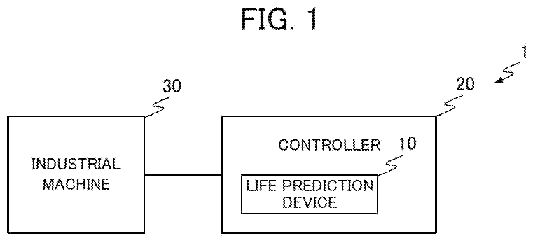

A first embodiment of the present invention will be described below with reference to FIGS. 1 to 10.

[1.1 Overall Configuration]

FIG. 1 is a diagram showing an overall configuration of a life prediction system 1 according to the first embodiment of the present invention. As shown in FIG. 1, the life prediction system 1 is provided with a controller 20 that includes a life prediction device 10, and an industrial machine 30. Here, the controller 20 and the industrial machine 30 are mutually communicably connected.

The life prediction device 10 is a device that predicts the life of a cable used in the industrial machine 30. Especially, the life prediction device 10 predicts the life of the cable used in the industrial machine 30 by using data acquired from the controller 20 that controls the industrial machine 30.

The controller 20 is an apparatus that controls the industrial machine 30. The controller 20 can be realized, for example, by causing a computer apparatus having a CPU, a memory, an input/output interface and the like to execute an appropriate control program. Especially, when the industrial machine 30 is a machine tool, the controller 20 controls a spindle and drive axes of the industrial machine as a machine tool according to a machining program, as a numerical controller. Further, when the industrial machine 30 is a robot, the controller 20 causes the industrial machine 30 as the robot to operate according to a given task program. Specifically, the controller 20 calculates an hourly position or speed of each drive axis of the industrial machine 30 required to perform motion according to the task program and applies a necessary current to each drive axis of the industrial machine 30. The industrial machine is not limited to a machine tool or a robot but may be, for example, an injection molding machine.

The industrial machine 30 is a machine having a drive unit the drive of which is automatically controlled by the controller 20. Especially, when the industrial machine 30 is a machine tool, the industrial machine 30 has a spindle to cause a tool to rotate and a feed shaft to cause the tool or a workpiece (not shown) to move, and causes the tool and the workpiece to relatively move to perform machining (for example, cutting machining) of the work. Further, when the industrial machine 30 is a robot, the industrial machine 30 may be an articulated robot such as a 6-axis vertical articulated or 4-axis horizontal articulated robot.

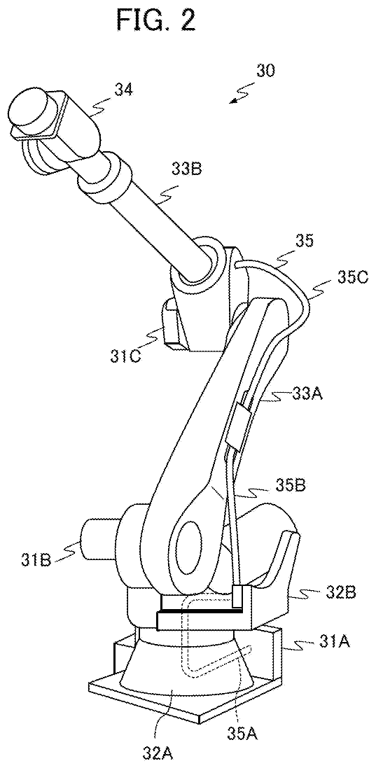

FIG. 2 shows a configuration example of the industrial machine 30 in a case where the industrial machine 30 is a robot. The industrial machine 30 is provided with a first joint 31A, a second joint 31B, a third joint 31C, a fixed base 32A, a rotating base 32B, a first arm 33A, a second arm 33B, a wrist 34 and a cable 35.

The first joint 31A causes the rotating base 32B to rotate around a vertical axis by rotationally driving the rotating base 32B, supporting the rotating base 32B from below. The second joint 31B is a joint that connects the rotating base 32B to the first arm 33A, and causes the first arm 33A to rotate around a horizontal axis by rotationally driving the first arm 33A. The third joint 31C is a joint that connects the first arm 33A to the second arm 33B, and causes the second arm 33B to rotate around a horizontal axis by rotationally driving the second arm 33B. The wrist 34 is attached to the tip of the second arm 33B, has a function of changing the orientation of a tool attached to the tip of the robot and usually has three motion axes. A tool not shown is attached to the tip of the wrist 34 and used to execute various kinds of tasks. As for the cable 35 in the example shown in FIG. 2, a movable part 35A is disposed at the first joint 31A; a movable part 35B is disposed at the second joint 31B; and a movable part 35C is disposed at the third joint 31C. The movable part 35A is wired inside the robot, and has a lower end portion attached to the fixed base 32A and an upper end portion attached to the rotating base 32B. The movable part 35B is wired along the second joint 31B, and has a lower end portion attached to the rotating base 32B and an upper end portion attached to the first arm 33A. The movable part 35C is wired along the third joint 31C, and has a lower end portion attached to the first arm 33A and an upper end portion attached to the second arm 33B.

In general, at a joint part between adjacent arms of a robot, a cable is wired such that it is fixed to the adjacent arms across the joint. Therefore, how much a cable of a movable part bends depends only on the angle of one joint. This is because, if a cable of a movable part is wired across a plurality of joints, behavior of the cable is influenced by motion of the plurality of joints, and motion of the cable cannot be stabilized. Therefore, in order to prevent the behavior of the cable from being complicated, the cable is wired such that it does not extend across a plurality of joints.

Especially, as for the cable 35, which has the movable part 35A being wired inside the robot, the movable part 35B being wired along the second joint 31B and the movable part 35C being wired along the third joint 31C, the life prediction device 10 predicts the life of the cable 35 especially based on a degree of deterioration of the movable part 35A, the movable part 35B and the movable part 35C due to motion of the industrial machine 30.

[1.2 Configuration of Life Prediction Device and Controller]

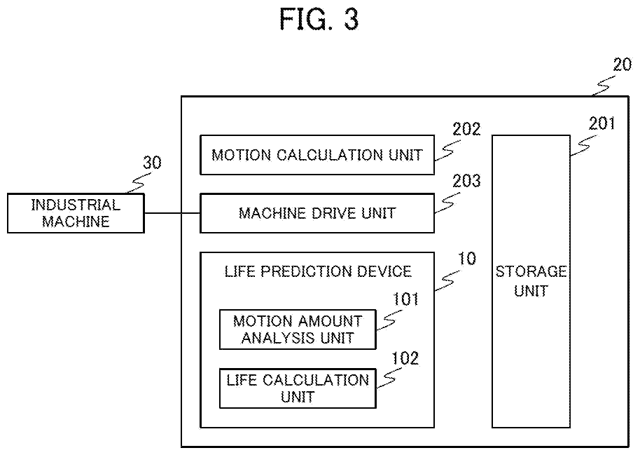

FIG. 3 is a functional block diagram of the controller 20 provided with the life prediction device 10.

The life prediction device 10 is provided with a motion amount analysis unit 101 and a life calculation unit 102.

The motion amount analysis unit 101 analyzes a motion amount of the motion axis of the industrial machine 30 based on a motion program for causing the industrial machine 30 to operate, which has been acquired from the controller 20.

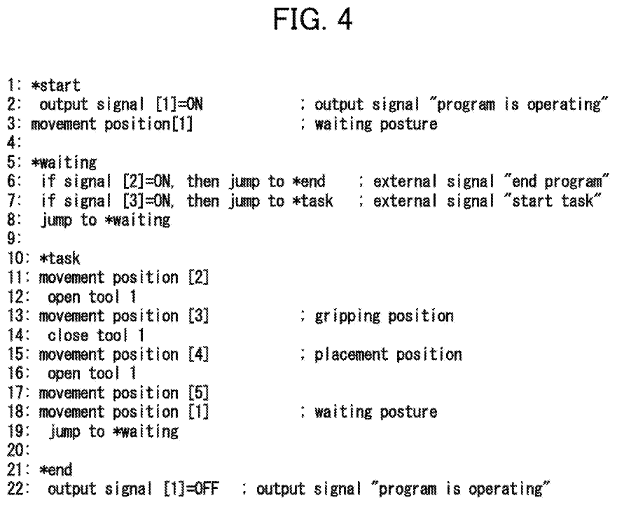

FIG. 4 shows an example of the motion program described above. In the example shown in FIG. 4, lines on which “move” is written are statements about motion of the industrial machine 30. In the motion program shown in FIG. 4, five teaching points of “position [1]” to “position [5]” are shown.

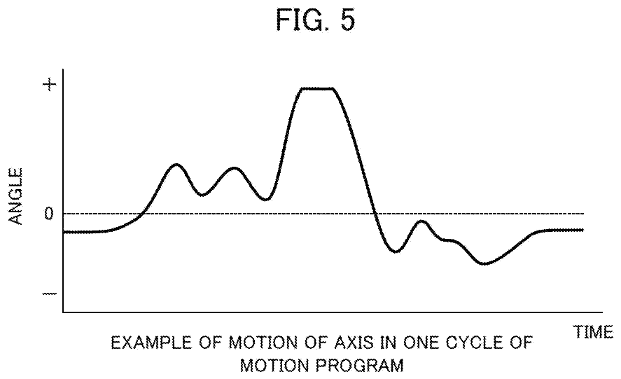

The controller 20 generates motion of passing through these teaching points based on instructions of the motion program. Furthermore, in order to realize the generated motion, the controller 20 calculates to which angle each axis should move for each certain point of time. FIG. 5 is a graph showing an example of axis motion in one cycle of the motion program.

Before actually causing the industrial machine 30 to operate, the motion amount analysis unit 101 analyzes a motion amount of each motion axis of the industrial machine 30 by acquiring a result of the above calculation from the controller 20.

The life calculation unit 102 calculates a predicted value of the life of the cable 35 by applying a relational expression between motion amount and cable life based on an Eyring model to the motion amount analyzed by the motion amount analysis unit 101.

Here, the Eyring model applied to the present embodiment can be indicated by Formula (1) below.

$$[ Formula 1 ]$$

$$\frac{{L}_{r}}{{L}_{t}} = {( \frac{{θ}_{r}}{{θ}_{t}} )}^{- α} \qquad ( 1 )$$

In Formula (1), Lᵣ indicates cable life (the number of cycles) in actual motion, Lₜ indicates cable life (the number of cycles) in a life test; θₜ indicates motion angle in the actual motion; θₜ indicates motion angle in the life test; and a is a constant.

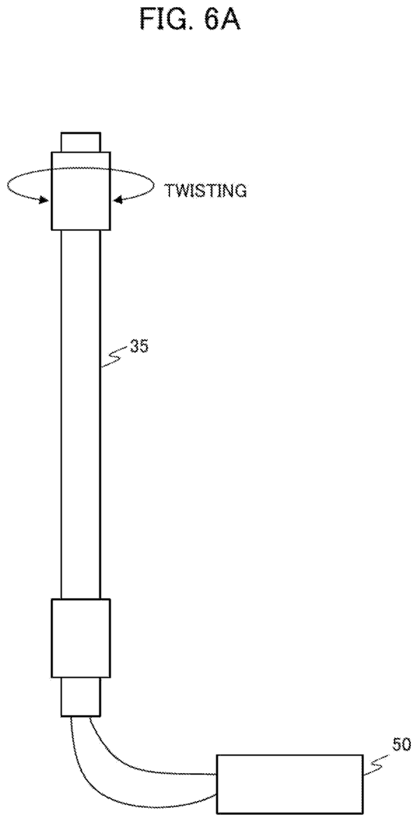

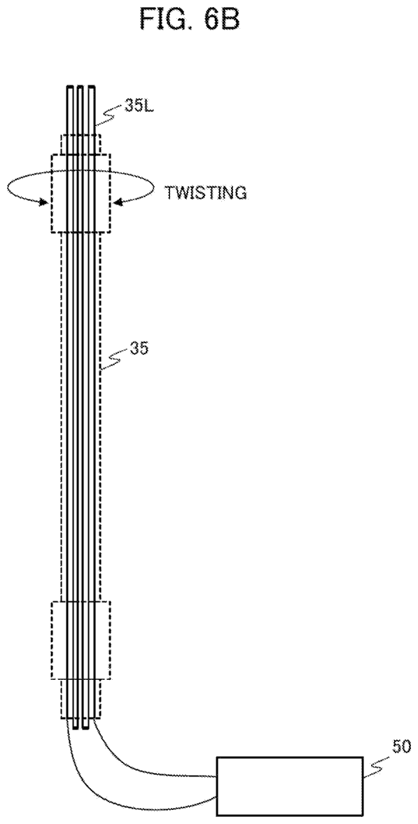

Furthermore, such a life test as below is executed beforehand to determine Lₜ and α. FIGS. 6A and 6B are diagrams schematically showing a method for the life test. As shown in FIG. 6A, a resistance measuring instrument 50 is connected to the cable 35, and the cable is twisted at predetermined twisting angles according to a plurality of load conditions to count the number of cycles at which resistance increases by 20%. Table 1 below shows an example of results of the test.

Here, “the number of cycles” refers to motion corresponding to one motion cycle. Referring to the program written in FIG. 4, one cycle is from the start until returning to the fifth line after executing the first to nineteenth lines of the program written in FIG. 4. In the life test of the cable 35, one reciprocating twisting or bending motion of the cable 35 corresponds to one cycle.

At the time of measuring resistance of the cable 35, all of a plurality of core wires 35L included in the cable 35 are soldered in series as shown in FIG. 6B, and resistance of the copper wires is measured.

TABLE 1

| | CABLE LIFE |
|---|---|
| | (THE NUMBER OF CYCLES |
| TWISTING | AT WHICH RESISTANCE |
| ANGLE | INCREASES BY 20%) |
| ±120° | 9,820,019 CYCLES |
| ±150° | 4,115,849 CYCLES |
| ±180° | 2,613,339 CYCLES |

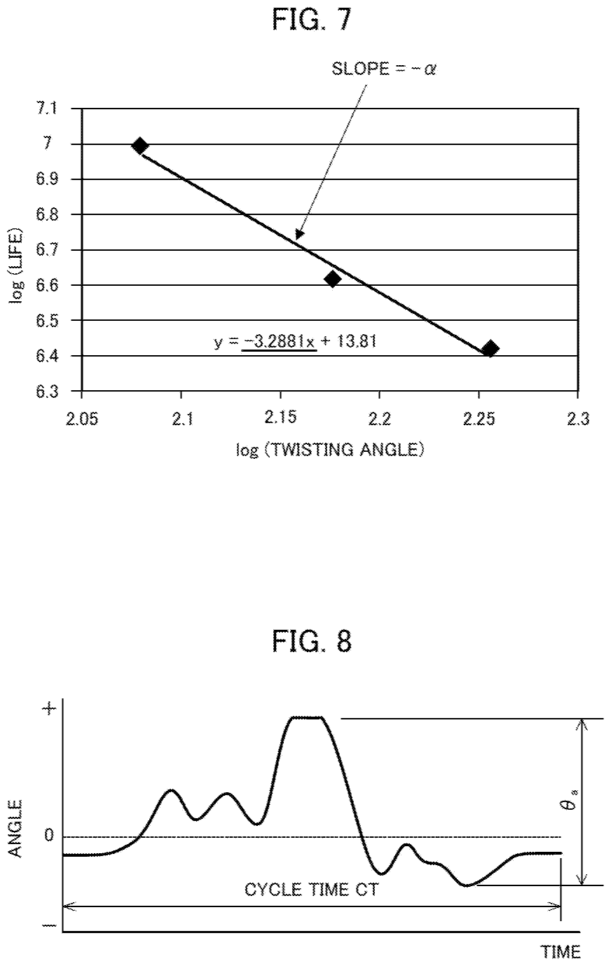

Next, the results of the life test shown in Table 1 are plotted on a graph with the horizontal axis as logarithmic representation of twisting angle and with the vertical axis as logarithmic representation of cable life. FIG. 7 shows an example of the plotted graph. The slope of a line obtained by approximating the plots on the graph exemplified in FIG. 7 is −α.

Examples of calculation of a cable life according to axis motion will be described below.

### 1.2.1 Life Calculation Example 1

FIG. 8 is a graph showing a first axis motion example. In the example shown in FIG. 8, one local maximum value (=the maximum value) and one local minimum value (=the minimum value) of motion angle exist in one cycle of the program.

At this time, by applying the Eyring model with a difference between the maximum value and minimum value of motion angle as a motion angle θₐ, a cable life (cycle) can be calculated by Formula (2) below.

$$[ Formula 2 ]$$

$${L}_{r} = {{L}_{t} ( \frac{{θ}_{a}}{{θ}_{t}} )}^{- α} \qquad ( 2 )$$

In Formula (2), Lᵣ indicates cable life (the number of cycles) in actual motion; Lₜ indicates cable life (the number of cycles) in the life test; and θₜ indicates motion angle in the life test.

By multiplying the cable life (the number of cycles) Lᵣ in actual motion calculated by Formula (2) by cycle time CT, cable life (time) in the actual motion is calculated.

### 1.2.2 Life Calculation Example 2

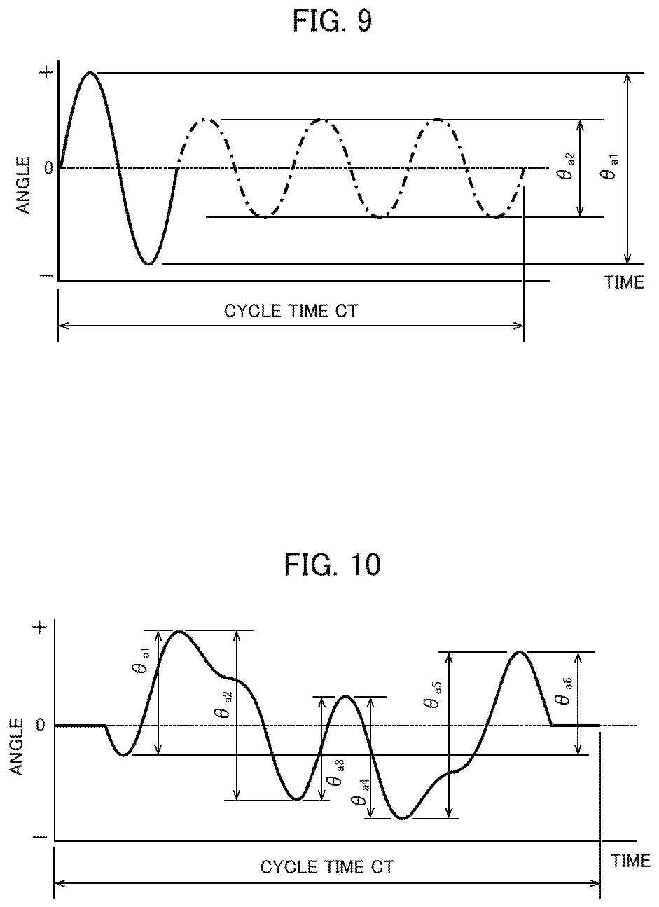

FIG. 9 is a graph showing a second axis motion example. In the example shown in FIG. 9, two kinds of motion angles θₐ₁ and θₐ₂ exist in one cycle of the program.

When the motion angle changes like the example shown in FIG. 9, the motion angles θₐ₁ and θₐ₂ are calculated first. Next, the number of times N₁, of the axis moving at the motion angle θₐ₁ and the number of times N₂ of the axis moving at the motion angle θₐ₂ are counted. In the case of the example shown in FIG. 9, N₁=1 and N₂=3 are obtained.

At this time, a cable life (cycle) can be calculated by Formula (3) based on the Eyring model and Formula (4) based on the Miner's rule below.

$$[ Formula 3 ]$$

$$\begin{matrix}{L}_{1} = {{L}_{t} ( \frac{{θ}_{a 1}}{{θ}_{t}} )}^{- α} & {L}_{2} = {{L}_{t} ( \frac{{θ}_{a 2}}{{θ}_{t}} )}^{- α}\end{matrix} \qquad ( 3 )$$

$$\frac{1}{{L}_{r}} = \frac{{N}_{1}}{{L}_{1}} + \frac{{N}_{2}}{{L}_{2}} \qquad ( 4 )$$

By multiplying the cable life (the number of cycles) Lᵣ in the actual motion calculated by Formula (4) by cycle time CT, a cable life (time) in the actual motion is calculated.

When Formulas (3) and (4) are generalized, Formulas (5) and (6) below are obtained.

$$[ Formula 4 ]$$

$${L}_{i} = {{L}_{t} ( \frac{{θ}_{ai}}{{θ}_{t}} )}^{- α} \qquad ( 5 )$$

$$\frac{1}{{L}_{r}} = {\sum }_{i} \frac{{N}_{i}}{{L}_{i}} \qquad ( 6 )$$

### 1.2.3 Life Calculation Example 3

FIG. 10 is a graph showing a third axis motion example. In the example shown in FIG. 10, the axis irregularly moves in one cycle of the program.

At this time, motion angles θₐ₁, θₐ₂, . . . , θₐ₁ from a local maximum value to the next local minimum value or from a local minimum value to the next local maximum value are calculated. Since these motion angles correspond to motions at values from a local maximum to a local minimum value or motions at values from a local minimum to a local maximum value, the number of times the axis moves at each of the motion angles θₐ₁, θₐ₂, . . . , θₐ₁ is counted as 0.5 times.

At this time, a cable life (cycle) can be calculated by Formula (7) based on the Eyring model and Formula (8) based on the Miner's rule below.

$$[ Formula 5 ]$$

$$\begin{matrix}{L}_{1} = {{L}_{t} ( \frac{{θ}_{a 1}}{{θ}_{t}} )}^{- α} & {L}_{2} = {{L}_{t} ( \frac{{θ}_{a 2}}{{θ}_{t}} )}^{- α} & … & {L}_{i} = {{L}_{t} ( \frac{{θ}_{ai}}{{θ}_{t}} )}^{- α}\end{matrix} \qquad ( 7 )$$

$$\frac{1}{{L}_{r}} = \frac{0.5}{{L}_{1}} + \frac{0.5}{{L}_{2}} + … + \frac{0.5}{{L}_{i}} \qquad ( 8 )$$

By multiplying the cable life (the number of cycles) Lᵣ in actual motion calculated by Formula (5) by cycle time CT, a cable life (time) in the actual motion is calculated.

The life calculation unit 102 calculates a predicted value of the life of the cable 35, for example, by any of the above methods of [1.2.1 Life calculation example 1] to [1.2.3 Life calculation example 3].

Returning to FIG. 3, the controller 20 is provided with a storage unit 201, a motion calculation unit 202, a machine drive unit 203 in addition to the life prediction device 10 described above.

The storage unit 201 mainly stores a control program for controlling the industrial machine 30. Especially, the storage unit 201 stores a machining program when the industrial machine 30 is a machine tool, and a task program when the industrial machine 30 is a robot.

The motion calculation unit 202 calculates a command value for causing the industrial machine 30 to operate, by analyzing the control program stored in the storage unit 201.

The machine drive unit 203 drives each axis that the industrial machine 30 is provided with, using the command value calculated by the motion calculation unit 202.

### 1.3 Operation of First Embodiment

In the life prediction device 10, the motion amount analysis unit 101 calculates a motion amount of each axis in one cycle of the motion program by analyzing the motion program of the industrial machine 30 acquired from the controller 20 first.

Next, the life calculation unit 102 calculates a predicted value of the life of the cable 35 by applying the relational expression between motion amount and cable life based on the Eyring model or the like to the motion amount of each axis analyzed by the motion amount analysis unit 101.

### 2 Second Embodiment

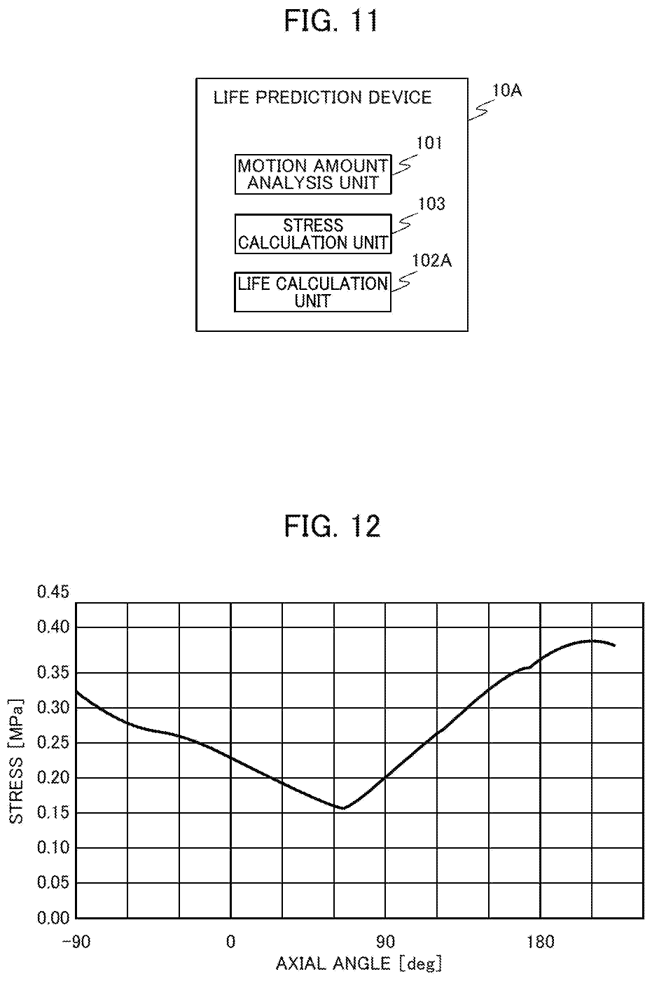

A second embodiment of the present invention will be described below with reference to FIGS. 11 to 15.

[2.1 Overall Configuration]

Unlike the life prediction system 1 according to the first embodiment, a life prediction system 1A according to the second embodiment of the present invention is provided with a life prediction device 10A instead of the life prediction device 10. Since the basic overall configuration is similar to the configuration shown in FIG. 1, it is not shown. In the description below, as for the same components as components that the life prediction device 10 is provided with, among components that the life prediction device 10A is provided with, they will be shown with the same reference signs, and description of their functions will be omitted.

[2.2 Configuration of Life Prediction Device]

FIG. 11 is a functional block diagram of the life prediction device 10A. Unlike the life prediction device 10, the life prediction device 10A is provided with a life calculation unit 102A instead of the life calculation unit 102 and is further provided with a stress calculation unit 103.

By applying a relationship between motion amount and stress on the cable 35, to a motion amount analyzed by the motion amount analysis unit 101, the stress calculation unit 103 calculates stress that occurs on the cable 35.

The first embodiment assumes that the axial angle of each axis of the industrial machine 30 and stress due to bending and twisting of the cable 35 are in proportion to each other. Actually, however, the axial angle of each axis and the stress due to bending and twisting of the cable 35 are not necessarily in proportion to each other.

Therefore, a relationship between motion amount and stress is calculated by simulation software for calculating behavior and stress of the cable 35, and stress calculated from this relationship is used for calculation of a cable life as described later.

FIG. 12 is a graph showing a relationship between motion amount (axial angle) and stress as a simulation result. In the second embodiment, the stress calculation unit 103 calculates stress that occurs on the cable 35, corresponding to each motion amount, by applying the relationship between motion amount and stress exemplified in FIG. 12 to the motion amount exemplified in FIG. 5.

The life calculation unit 102A calculates a predicted value of the life of the cable 35 by applying a relational expression between stress and life of the cable 35 based on an Eyring model to the stress calculated by the stress calculation unit 103.

Here, the Eyring model applied to the present embodiment can be indicated by Formula (9) below.

$$[ Formula 6 ]$$

$$\frac{{L}_{r}}{{L}_{t}} = {( \frac{{S}_{r}}{{S}_{t}} )}^{- α} \qquad ( 9 )$$

In Formula (9), Lᵣ indicates cable life (the number of cycles) in actual motion; Lₜ indicates cable life (the number of cycles) in a life test, Sᵣ indicates stress in actual motion; Sₜ indicates stress in the life test; and a is a constant.

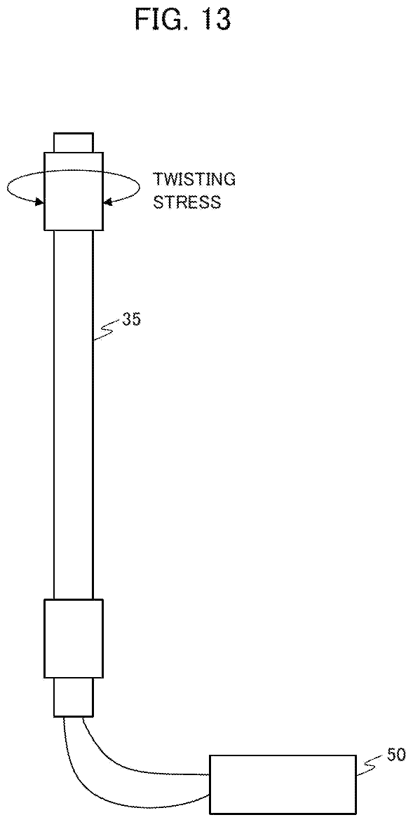

Furthermore, such a life test as below is executed beforehand to determine Lₜ and α. FIG. 13 is a diagram schematically showing a method for the life test. As shown in FIG. 13, the resistance measuring instrument 50 is connected to the cable 35, and the cable is twisted at predetermined twisting angles according to a plurality of load conditions to count the number of cycles at which resistance increases by 20% while calculating stresses corresponding to the twisting angles. Table 2 below shows an example of results of the test.

TABLE 2

| | CABLE LIFE |
|---|---|
| | (THE NUMBER OF CYCLES |
| | AT WHICH RESISTANCE |
| STRESS | INCREASES BY 20%) |
| 0.6 MPa | 9,820,019 CYCLES |
| 0.5 MPa | 4,115,849 CYCLES |
| 0.4 MPa | 2,613,339 CYCLES |

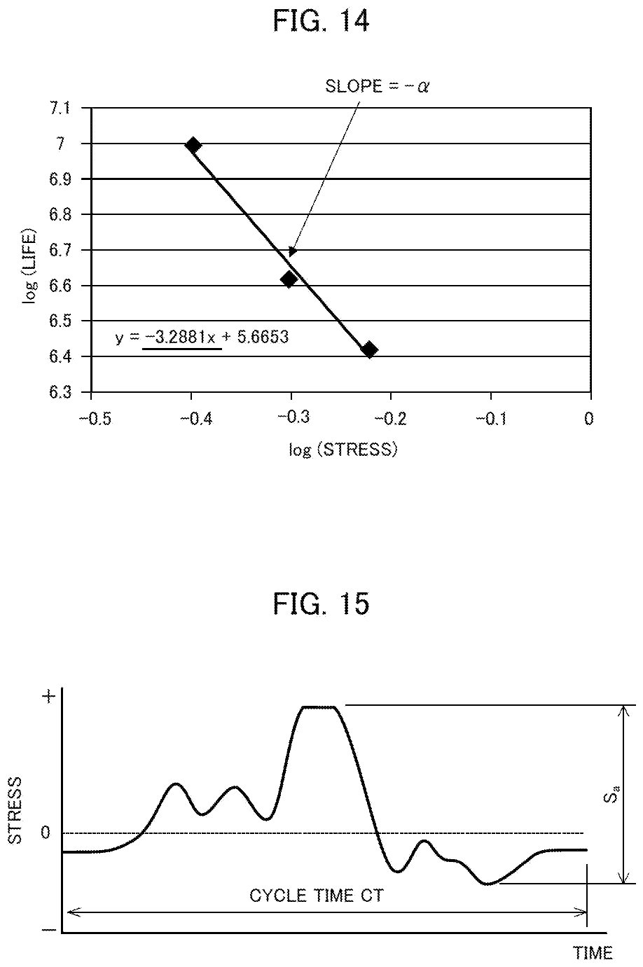

Next, the results of the life test shown in Table 2 are plotted on a graph with the horizontal axis as logarithmic representation of stress and with the vertical axis as logarithmic representation of cable life. FIG. 14 shows an example of a plotted graph. The slope of a line obtained by approximating the plots on the graph exemplified in FIG. 7 is −α.

Examples of calculation of a cable life according to axis motion will be described below.

### 2.2.1 Life Calculation Example 4

FIG. 15 is a graph showing a stress fluctuation example. In the example shown in FIG. 15, one local maximum value (=the maximum value) and one local minimum value (=the minimum value) of stress exist in one cycle of the program.

At this time, by applying the Eyring model with a difference between the maximum value and minimum value of stress as a stress amplitude Sₐ, a cable life (cycle) can be calculated by Formula (10) below.

$$[ Formula 7 ]$$

$${L}_{r} = {{L}_{t} ( \frac{{S}_{a}}{{S}_{t}} )}^{- α} \qquad ( 10 )$$

In Formula (10), Lᵣ indicates cable life (the number of cycles) in actual motion; Lₜ indicates cable life (the number of cycles) in the life test; and Sₜ indicates stress in the life test.

By multiplying the cable life (the number of cycles) Lᵣ in the actual motion calculated by Formula (10) by cycle time CT, cable life (time) in the actual motion is calculated.

### 2.3 Operation of Second Embodiment

In the life prediction device 10A, the motion amount analysis unit 101 calculates a motion amount of each axis in one cycle of the motion program by analyzing the motion program of the industrial machine 30 acquired from the controller 20 first.

Next, by applying a relationship between motion amount and stress that occurs on the cable 35, to the motion amount analyzed by the motion amount analysis unit 101, the stress calculation unit 103 calculates stress.

Lastly, the life calculation unit 102A calculates a predicted value of the life of the cable 35 by applying the relational expression between stress and cable life based on the Eyring model or the like to the stress calculated by the stress calculation unit 103.

### 3 Third Embodiment

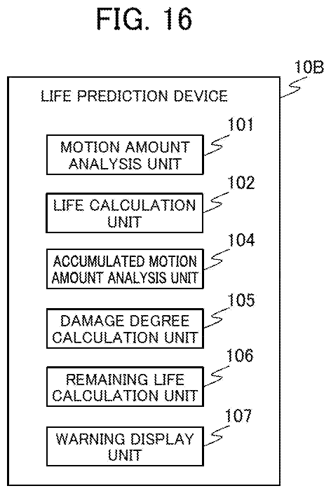

A third embodiment of the present invention will be described below with reference to FIG. 16.

Due to delay in motion of a motor relative to motion calculated and instructed by software, stop time because of waiting for a signal, stop of operation on holidays and at night, axis motion being compensated based on information from a sensor such as a visual sensor, or the like, actual motion of the industrial machine 30 and motion in the case of continuously and repeatedly executing the motion program do not completely correspond to each other.

Here, referring to the program written in FIG. 4, the fifth to eighth lines indicate a command to wait for a signal. In the case of calculating a life only by the program, it is assumed that products are always flowing down the line. Actually, however, waiting for a signal may occur as shown in the program written in FIG. 4. Therefore, it is desirable to calculate a life from actual motion data.

Therefore, in the present embodiment, for an industrial machine that are operating, reduction in the life of a cable from start of the operation up to the present is determined from data of actual motion.

[3.1 Overall Configuration]

Unlike the life prediction system 1 according to the first embodiment, a life prediction system 1B according to the third embodiment of the present invention is provided with a life prediction device 10B instead of the life prediction device 10. Since the basic overall configuration is similar to the configuration shown in FIG. 1, it is not shown. In the description below, as for the same components as components that the life prediction device 10 is provided with, among components that the life prediction device 10B is provided with, they will be shown with the same reference signs, and description of their functions will be omitted.

[3.2 Configuration of Life Prediction Device]

FIG. 16 is a functional block diagram of the life prediction device 10B. Unlike the life prediction device 10, the life prediction device 10B is provided with an accumulated motion amount analysis unit 104, a damage degree calculation unit 105, a remaining life calculation unit 106 and a warning display unit 107 in addition to the motion amount analysis unit 101 and the life calculation unit 102.

The accumulated motion amount analysis unit 104 analyzes an accumulated motion amount of each motion axis that the industrial machine 30 is provided with, based on past motion records of the industrial machine 30.

Specifically, by a method similar to the method of calculating the motion angles from a local maximum value to the next local minimum value or from a local minimum value to the next local maximum value θₐ₁, θₐ₂, . . . , θₐ₁. in [1.2.3 Life calculation example 3], the accumulated motion amount analysis unit 104 calculates motion angles from a local maximum value to the next local minimum value or from a local minimum value to the next local maximum value θₐ₁, θₐ₂, . . . , θₐ₁ based on records of motions from start of operation of a robot to the present.

Since these motion angles correspond to motions at values from a local maximum to a local minimum value or motions at values from a local minimum to a local maximum value, the number of times the axis moves at each of the motion angles θₐ₁, θₐ₂, . . . , θₐ₁ is counted as 0.5 times. Note that i is expected to be 300,000 or more in one year.

The past motion records may be what are based on motion commands calculated in the controller 20 or may be what are based on feedback from a position sensor provided for the industrial machine 30.

The damage degree calculation unit 105 calculates a damage degree by applying a relational expression between accumulated motion amount and damage degree of cable based on an Eyring model to the accumulated motion amount analyzed by the accumulated motion amount analysis unit 104.

Specifically, a damage degree of the cable 35 is calculated by using Formula (11) based on the Eyring model and Formula (12) based on the Miner's rule below.

$$[ Formula 8 ]$$

$$\begin{matrix}{L}_{1} = {{L}_{t} ( \frac{{θ}_{a 1}}{{θ}_{t}} )}^{- α} & {L}_{2} = {{L}_{t} ( \frac{{θ}_{a 2}}{{θ}_{t}} )}^{- α} & … & {L}_{i} = {{L}_{t} ( \frac{{θ}_{ai}}{{θ}_{t}} )}^{- α}\end{matrix} \qquad ( 11 )$$

$$D = \frac{0.5}{{L}_{1}} + \frac{0.5}{{L}_{2}} + … + \frac{0.5}{{L}_{i}} \qquad ( 12 )$$

Here, D indicates the damage degree of the cable 35 and is a value satisfying 0≤D<1 when the cable 35 has not reached the end of its life. Further, Lₜ indicates cable life (cycle) in a life test. Further, θₜ indicates motion angle in the life test.

The remaining life calculation unit 106 calculates a predicted value of the remaining life of the cable 35 from a predicted value of a cable life calculated by the life calculation unit 102 and a damage degree of the cable 35 calculated by the damage degree calculation unit 105.

Specifically, the predicted value Lᵣ, of the remaining life of the cable 35 is calculated by substituting the damage degree D and the predicted value Lᵣ of the cable life into Formula (9) below.

Lᵣₘ=(1−D)×Lᵣ (9)

When the remaining life calculated by the remaining life calculation unit 106 is below a threshold, the warning display unit 107 displays a warning on a display unit 120 described later.

The life prediction device 10B is provided with the display unit 120. For example, the display unit 120 displays a warning as described above. The display unit 120 can be realized, for example, by a liquid crystal monitor.

### 3.3 Operation of Third Embodiment

In the life prediction device 10B, the motion amount analysis unit 101 calculates a motion amount of each axis in one cycle of the motion program by analyzing the motion program of the industrial machine 30 acquired from the controller 20 first.

Next, the life calculation unit 102 calculates a predicted value of the cable 35 by applying a relational expression between motion amount and cable life based on the Eyring model or the like to the motion amount of each axis analyzed by the motion amount analysis unit 101.

Next, the accumulated motion amount analysis unit 104 analyzes an accumulated motion amount of each motion axis that the industrial machine 30 is provided with, based on past motion records of the industrial machine 30.

Next, the damage degree calculation unit 105 calculates a damage degree by applying the relational expression between accumulated motion amount and damage degree of cable based on the Eyring model to the analyzed accumulated motion amount.

Next, the remaining life calculation unit 106 calculates a predicted value of the remaining life of the cable 35 from the predicted value of the cable life calculated by the life calculation unit 102 and the damage degree of the cable 35 calculated by the damage degree calculation unit 105.

Lastly, when the remaining life is below the threshold, the warning display unit 107 displays a warning on the display unit 120.

### 4 Fourth Embodiment

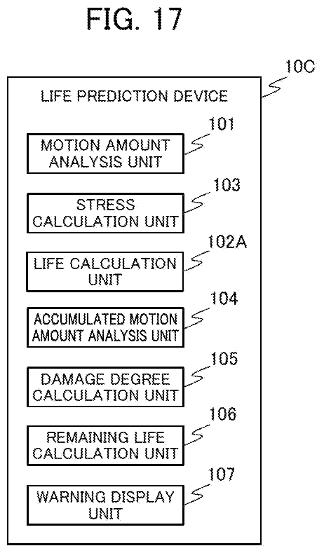

A fourth embodiment of the present invention will be described below with reference to FIG. 17.

The life prediction device 10B according to the third embodiment of the present invention is generally such that, by adding the accumulated motion amount analysis unit 104, the damage degree calculation unit 105, the remaining life calculation unit 106 and the warning display unit 107 to the life prediction device 10 according to the first embodiment, calculates a predicted value of the remaining life of the cable 35 based on records of motions from start of operation of the industrial machine 30 to the present, and issues a warning when the remaining life is below a threshold.

In comparison, the life prediction device 10C according to the fourth embodiment of the present invention is generally such that, by adding the accumulated motion amount analysis unit 104, the damage degree calculation unit 105, the remaining life calculation unit 106 and the warning display unit 107 to the life prediction device 10A according to the second embodiment, calculates a predicted value of the remaining life of the cable 35 based on records of motions from start of operation of the industrial machine 30 to the present, and issues a warning when the remaining life is below a threshold.

### 4.1 Overall Configuration

Unlike the life prediction system 1 according to the first embodiment, a life prediction system 1C according to the fourth embodiment of the present invention is provided with a life prediction device 10C instead of the life prediction device 10. Since the basic overall configuration is similar to the configuration shown in FIG. 1, it is not shown. In the description below, as for the same components as components that the life prediction devices 10, 10A and 10B are provided with, among components that the life prediction device 10C is provided with, they will be shown with the same reference signs, and description of their functions will be omitted.

[4.2 Configuration of Life Prediction Device]

FIG. 17 is a functional block diagram of the life prediction device 10C. Unlike the life prediction device 10A, the life prediction device 10C is provided with the accumulated motion amount analysis unit 104, the damage degree calculation unit 105, the remaining life calculation unit 106 and the warning display unit 107 in addition to the motion amount analysis unit 101, the life calculation unit 102A and the stress calculation unit 103.

### 4.3 Operation of Fourth Embodiment

In the life prediction device 10C, the motion amount analysis unit 101 calculates a motion amount of each axis in one cycle of the motion program by analyzing the motion program of the industrial machine 30 acquired from the controller 20 first.

Next, by applying a relationship between motion amount and stress that occurs on the cable 35, to a motion amount analyzed by the motion amount analysis unit 101, the stress calculation unit 103 calculates stress.

Next, the life calculation unit 102A calculates a predicted value of the cable 35 by applying a relational expression between stress and cable life based on an Eyring model or the like to the stress calculated by the stress calculation unit 103.

Next, the accumulated motion amount analysis unit 104 analyzes an accumulated motion amount of each motion axis that the industrial machine 30 is provided with, based on past motion records of the industrial machine 30.

Next, the damage degree calculation unit 105 calculates a damage degree by applying a relational expression between accumulated motion amount and damage degree of cable based on the Eyring model to the analyzed accumulated motion amount.

Next, the remaining life calculation unit 106 calculates a predicted value of the remaining life of the cable 35 from the predicted value of the cable life calculated by the life calculation unit 102 and the damage degree of the cable 35 calculated by the damage degree calculation unit 105.

Lastly, when the remaining life is below the threshold, the warning display unit 107 displays a warning on the display unit 120.

### 5 Effects Obtained by First to Fourth Embodiments

(1) One of the life prediction devices according to the above embodiments is a life prediction device (for example, “the life prediction device 10” described above) for a cable used in an industrial machine (for example, “the industrial machine 30” described above), and is provided with: a motion amount analysis unit (for example, “the motion amount analysis unit 101” described above) that analyzes a motion amount of a motion axis of the industrial machine based on a motion program for causing the industrial machine to operate; and a life calculation unit (for example, “the life calculation unit 102” described above) that calculates a predicted value of a life of the cable by applying a relational expression between motion amount and cable life based on an Eyring model to the motion amount.

Thereby, it becomes possible to, in order to reduce a maintenance burden on a user, calculate an actual life of a cable, which is an original life of the cable, and extend the interval of replacement of the cable. Especially, it is possible provide information about appropriate time of replacement of the cable 35 calculated from motion of the industrial machine 30 for a user to reduce the maintenance burden on the user. Further, especially for a motion axis that performs a rotational motion, the life of the cable 35 that is wired on the motion axis is much influenced by a motion amount. Therefore, it becomes possible to extend a replacement interval of the cable 35 especially for the industrial machine 30 having many rotational motion axes.

(2) One of the life prediction devices according to the above embodiments is a life prediction device (for example, “the life prediction device 10A” described above) for a cable used in an industrial machine (for example, “the industrial machine 30” described above), and is provided with: a motion amount analysis unit (for example, “the motion amount analysis unit 101” described above) that analyzes a motion amount of a motion axis of the industrial machine based on a motion program for causing the industrial machine to operate; a stress calculation unit (for example, “the stress calculation unit 103” described above) that calculates stress that occurs on the cable, by applying a relationship between motion amount and stress on the cable to the motion amount; and a life calculation unit (for example, “the life calculation unit 102A” described above) that calculates a predicted value of the life of the cable by applying a relational expression between stress and cable life based on an Eyring model to the stress.

Thereby, even when the angle of each component constituting the industrial machine 30 and stress due to bending and twisting of the cable disposed on the component are not in proportion to each other, it becomes possible to, in order to reduce a maintenance burden on a user, calculate an actual life of the cable, which is an original life of the cable, and extend the interval of replacement of the cable.

(3) The life prediction device according to (1) or (2) may be further provided with: an accumulated motion amount analysis unit (for example, “the accumulated motion amount analysis unit 104” described above) that analyzes an accumulated motion amount of the motion axis based on past motion records of the industrial machine; a damage degree calculation unit (for example, “the damage degree calculation unit 105” described above) that calculates a damage degree of the cable by applying a relationship between accumulated motion amount and damage degree of the cable based on the Eyring model to the accumulated motion amount; and a remaining life calculation unit (for example, “the remaining life calculation unit 106” described above) that calculates a predicted value of a remaining life of the cable from the predicted value of the life of the cable and the damage degree.

Thereby, it is possible provide information about appropriate time of replacement of the cable 35 calculated from motion of the industrial machine 30 in the past for the user to reduce the maintenance burden on the user.

(4) The life prediction device according to (3) may be provided with a warning display unit (for example, “the warning display unit 107” described above) that displays a warning when the remaining life is below a threshold.

Thereby, it becomes possible for an operator of the life prediction device 10B or 10C to recognize the appropriate cable replacement time.

### 6 Modification Example

### 6.1 Modification Example 1

As for the life prediction device 10A according to the second embodiment described above, an example of calculating a predicted value of the life of a cable by executing [2.2.1 Life calculation example 4] obtained by replacing motion angle with stress in [1.2.1 Life calculation example 1] executed by the life prediction device 10 in the first embodiment has been described, but the life prediction device 10A is not limited thereto.

For example, a predicted value of the life of a cable may be calculated by a method obtained by replacing motion angle with stress in [1.2.2 Life calculation example 2] and [1.2.3 Life calculation example 3].

### 6.2 Modification Example 2

The life prediction device 10 according to the first embodiment and the life prediction device 10A according to the second embodiment are assumed not to be provided with a display unit, but the life prediction devices 10 and 10A are not limited thereto. For example, the life prediction device 10 or 10A may be provided with a display unit and display a predicted value of a life calculated by the life calculation unit 102 or 102A on the display unit. In these cases, and in the life prediction device 10B according to the third embodiment and the life prediction device 10C according to the fourth embodiment, the display unit may not be configured being incorporated in each of the life prediction devices 10 to 10C but may be separate from each of the life prediction device 10 to 10C. Or alternatively, the display unit may be configured being incorporated in the controller 20.

### 6.3 Modification Example 3

Further, each of the life prediction device 10 according to the first embodiment to the life prediction device 10C according to the fourth embodiment described above is assumed to be separate from the industrial machine 30 but is not limited thereto. For example, each of the life prediction devices 10 to 10C may be incorporated into and integrated with the industrial machine 30.

### 6.4 Modification Example 4

Further, each of the life prediction device 10 according to the first embodiment to the life prediction device 10C according to the fourth embodiment described above is a device that executes life prediction of a cable as one function of the controller 20, but is not limited thereto. For example, the life prediction devices may realize a function of performing simulation based on motion data for one cycle of a robot to estimate the life of the cable used for the robot as one function of such a PC tool that examines construction of a robot system offline.

Each component unit included in the life prediction devices 10 to 10C and the life prediction systems 1 to 1C can be realized by hardware, software or a combination thereof. Further, a data collection method performed by cooperation among the component units included in each of the life prediction devices 10 to 10C and the life prediction systems 1 to 1C can also be realized by hardware, software or a combination thereof. Here, being realized by software means being realized by a computer reading and executing a program.

The program can be stored using any of various types of non-transitory computer-readable media and supplied to the computer. The non-transitory computer-readable media include various types of tangible storage media. Examples of the non-transitory computer-readable media include a magnetic recording medium (for example, a flexible disk, a magnetic tape or a hard disk drive), a magneto-optical recording medium (for example, a magneto-optical disk), a CD-ROM (read-only memory), a CD-R, a CD-R/W, and a semiconductor memory (for example, a mask ROM, a PROM (programmable ROM), an EPROM (erasable PROM), a flash ROM or a RAM (random access memory)). The program may be supplied to the computer by any of various types of transitory computer-readable media. Examples of the transitory computer-readable media include an electrical signal, an optical signal and electromagnetic waves. The transitory computer-readable media can supply the program to the computer via a wired communication channel such as an electrical wire or optical fibers or a wireless communication channel.

### EXPLANATION OF REFERENCE NUMERALS

1, 1A, 1B, 1C: Life prediction system
10, 10A, 10B, 10C: Life prediction device
101: Motion amount analysis unit
102, 102A: Life calculation unit
103: Stress calculation unit
104: Accumulated motion amount analysis unit
105: Damage degree calculation unit
106: Remaining life calculation unit
107: Warning display unit
120: Display unit
201: Storage unit

1. A life prediction device for a cable used in an industrial machine, the life prediction device comprising:
a motion amount analysis unit that analyzes a motion amount of a motion axis of the industrial machine based on a motion program for causing the industrial machine to operate; and
a life calculation unit that calculates a predicted value of a life of the cable by applying a relational expression between motion amount and cable life based on an Eyring model to the motion amount.

2. A life prediction device for a cable used in an industrial machine, the life prediction device comprising:
a motion amount analysis unit that analyzes a motion amount of a motion axis of the industrial machine based on a motion program for causing the industrial machine to operate;
a stress calculation unit that calculates stress that occurs on the cable, by applying a relationship between motion amount and stress on the cable to the motion amount; and
a life calculation unit that calculates a predicted value of a life of the cable by applying a relational expression between stress and cable life based on an Eyring model to the stress.

3. The life prediction device according to claim 1, further comprising:
an accumulated motion amount analysis unit that analyzes an accumulated motion amount of the motion axis based on past motion records of the industrial machine;
a damage degree calculation unit that calculates a damage degree of the cable by applying a relationship between accumulated motion amount and damage degree of the cable based on the Eyring model to the accumulated motion amount; and
a remaining life calculation unit that calculates a predicted value of a remaining life of the cable from the predicted value of the life of the cable and the damage degree.

4. The life prediction device according to claim 3, further comprising:
a warning display unit that displays a warning when the remaining life is below a threshold.

5. An industrial machine comprising:
the life prediction device according to claim 1; and
a life display device that displays the life.

6. A program creation system comprising:
the life prediction device according to claim 1; and
a life display device that displays the life.

7. A non-transitory computer-readable medium storing a program for causing a computer to function as a life prediction device for a cable used in an industrial machine, the program causing, by being executed on the computer, the computer to perform processes that comprise:
a motion amount analysis process for analyzing a motion amount of a motion axis of the industrial machine based on a motion program for causing the industrial machine to operate; and
a life calculation process for calculating a predicted value of a life of the cable by applying a relational expression between motion amount and cable life based on an Eyring model to the motion amount.

8. A non-transitory computer-readable medium storing a program for causing a computer to function as a life prediction device for a cable used in an industrial machine, the program causing, by being executed on the computer, the computer to perform processes that comprise:
a motion amount analysis process for analyzing a motion amount of a motion axis of the industrial machine based on a motion program for causing the industrial machine to operate;
a stress calculation process for calculating stress that occurs on the cable, by applying a relationship between motion amount and stress on the cable to the motion amount; and
a life calculation process for calculating a predicted value of a life of the cable by applying a relational expression between stress and cable life based on an Eyring model to the stress.
